(19) United States
(12) Patent Application Publication
(10) Pub. No.: US 2013/0229152 A1
(43) Pub. Date: Sep. 5, 2013

(54) POWER SUPPLY STACK REPLACEMENT METHOD, CONTROL DEVICE, AND STORAGE MEDIUM STORING CONTROL PROGRAM

(71) Applicant: Yasuhide Kurimoto, Kasugai-shi (JP)

(72) Inventor: Yasuhide Kurimoto, Kasugai-shi (JP)

(21) Appl. No.: 13/885,008

(22) PCT Filed: Nov. 21, 2011
(86) PCT No.: PCT/IB2011/002768

§ 371 Date: May 13, 2013

(30) Foreign Application Priority Data
Nov. 22, 2010 (JP) 2010-259944

(51) Int. Cl. H02J 7/00

(52) U.S. Cl. CPC H02J 7/0014
USPC 320/126

(57) ABSTRACT

A power supply stack replacement method includes: discharging or charging power supply stacks of a power supply device in which the power supply stacks are electrically connected in parallel with each other until the SOC of each of the power supply stacks becomes a predetermined value; and replacing a targeted power supply stack among the power supply stacks of which the SOC is the predetermined value through the charging or discharging with a replacement power supply stack.

### BACKGROUND OF THE INVENTION

1. Field of the Invention

The invention relates to a power supply stack replacement method for a power supply device that includes a plurality of power supply stacks, a control device and a storage medium storing a control program.

2. Description of Related Art

A plurality of cell stacks may be mounted on a vehicle, or the like. Each of the cell stacks is formed of a plurality of single cells that are arranged in one direction, and outputs energy for propelling the vehicle.

A battery pack is formed so that a plurality of cell stacks are electrically connected in parallel with or in series with one another. However, when there occurs a malfunction, such as performance degradation and failure, in part of the plurality of cell stacks, the performance of the whole battery pack decreases, so replacement of the malfunctioned cell stack is required (for example, see Japanese Patent Application Publication No. 2002-15781 (JP-A-2002-15781)).

However, after stack replacement, when there is a difference in the state of charge (SOC) between the replaced cell stack and the other non-replaced cell stacks, there is a problem that a travel distance based on the electric energy of the battery pack reduces.

When there is such a difference in SOC between the cell stacks, equalizing control (equalizing circuit) in discharge/charge control during vehicle running is used to equalize the SOCs at a predetermined current value; however, when the current value used to equalize the SOCs is small, it takes much time to equalize the SOC of the replaced cell stack and the SOCs of the other non-replaced cell stacks.

Therefore, at the time of replacing cell stacks of a battery pack in which a plurality of cell stacks are connected in parallel with one another, when there is a difference in SOC (difference in voltage) between the parallel connected sets of cell stacks, the performance of the battery pack cannot be sufficiently exhibited until the SOCs are equalized after replacement of the battery stacks, so there is a possibility that a travel distance based on electric energy is reduced or the vehicle cannot run using electric energy.

In addition, battery stacks used for propelling vehicles have high energy in recent years, so, when replacement is conducted in a state where there is a difference in SOC among the cell stacks. The difference in SOC may influence replacement work.

### SUMMARY OF THE INVENTION

The invention provides a power supply stack replacement method for a power supply device in which power supply stacks are connected in parallel with one another, a control device, and a storage medium storing a control program.

A first aspect of the invention provides a power supply stack replacement method that, in a power supply device in which power supply stacks are electrically connected in parallel with each other, replaces a targeted power supply stack, which is part of the power supply stacks, with a replacement power supply stack. The power supply stack replacement method includes: discharging or charging the parallel connected power supply stacks until a state of charge (SOC) of each of the power supply stacks becomes a predetermined value; and replacing the targeted power supply stack among the power supply stacks of which each state of charge (SOC) is the predetermined value through the discharging or charging with the replacement power supply stack.

In the aspect of the invention described above, the discharging or charging the parallel connected power supply stacks may include: discharging or charging a whole of the parallel connected power supply stacks; and stopping discharging or charging one of the power supply stacks of which the state of charge has reached the predetermined value and discharging or charging the other one of the power supply stacks of which the state of charge has not reached the predetermined value until the state of charge of the other one of the power supply stacks reaches the predetermined value.

Furthermore, In the first aspect of the invention described above, the discharging or charging the parallel connected power supply stacks may include: discharging or charging a selected one of the parallel connected power supply stacks until a state of charge of the selected one of the power supply stacks becomes the predetermined value and, after the state of charge of the selected one of the power supply stacks has reached the predetermined value, discharging or charging the other one of the parallel connected power supply stacks until a state of charge of the other one of the power supply stacks becomes the predetermined value.

In the first aspect of the invention described above, the discharging or charging the parallel connected power supply stacks may include: discharging the parallel connected power supply stacks until a state of charge (SOC) of one of the power supply stacks, having a low state of charge (SOC), becomes the predetermined value; and, after the state of charge (SOC) of the one of the power supply stacks, having a low state of charge (SOC), has reached the predetermined value, discharging the other one of the parallel connected power supply stacks until a state of charge (SOC) of the other one of the parallel connected power supply stacks becomes the predetermined value.

Alternatively, In the first aspect of the invention described above, the discharging or charging the parallel connected power supply stacks may include: charging the parallel connected power supply stacks until a state of charge (SOC) of one of the power supply stacks, having a high state of charge (SOC), becomes a predetermined value; and, after the state of charge (SOC) of the one of the power supply stacks, having a high state of charge (SOC), has reached the predetermined value, charging the other one of the parallel connected power supply stacks until a state of charge of the other one of the power supply stacks becomes the predetermined value.

In the above described aspect of the invention, a discharge current from the parallel connected power supply stacks may be output to an electric power consuming device. The electric power consuming device may be equipped for a vehicle. The power supply stacks may be charged with electric power supplied from an external charger.

In the above described aspect of the invention, the power supply stack replacement method may further include determining whether there is a difference in state of charge between the parallel connected power supply stacks. The predetermined value may be a state of charge (SOC) of the replacement power supply stack.

A second aspect of the invention provides a power supply stack replacement method that, in a power supply device in which power supply stacks are electrically connected in parallel with each other, replaces a targeted power supply stack, which is part of the power supply stacks, with a replacement power supply stack. The power supply stack replacement method includes: discharging or charging the replacement power supply stack until a state of charge (SOC) of the replacement power supply stack is equal to a state of charge (SOC) of one of the parallel connected power supply stacks; discharging or charging the other one of the parallel connected power supply stacks until a state of charge (SOC) of the other one of the power supply stacks is equal to the state of charge (SOC) of the one of the power supply stacks; and replacing the targeted power supply stack among the parallel connected power supply stacks with the discharged or charged replacement power supply stack.

A third aspect of the invention provides a power supply stack replacement method that, in a power supply device in which power supply units, each of which is formed of a plurality of electrically connected power supply stacks, are electrically connected in parallel with each other, replaces a targeted power supply stack, which is part of the power supply stack included in any one of the power supply units, with a replacement power supply stack. The power supply stack replacement method includes: discharging or charging the power supply units until a state of charge (SOC) of each of the power supply units becomes a predetermined value; and replacing the targeted power supply stack among the power supply stacks included in the power supply units of which each state of charge (SOC) is the predetermined value through the charging or discharging with the replacement power supply stack.

A fourth aspect of the invention provides a control device that, when a targeted power supply stack, which is part of power supply stacks included in a power supply device in which the power supply stacks are electrically connected in parallel with each other, is replaced with a replacement power supply stack, controls a state of charge (SOC) of each of the power supply stacks. The control device includes: a stack replacement control unit that determines whether there is a difference in state of charge (SOC) between the parallel connected power supply stacks; and a charge/discharge control unit that, when there is a difference in state of charge (SOC) between the power supply stacks, executes discharge control for discharging the power supply stacks through a predetermined electric power consuming device or charge control for charging the power supply stacks from an external charger until the state of charge (SOC) of each of the power supply stacks becomes a predetermined value.

A fifth aspect of the invention provides a computer-readable storage medium storing a control program executable on a control device that is connected to a power supply device in which power supply stacks are electrically connected in parallel with each other and that executes a maintenance mode in which a targeted power supply stack, which is part of the power supply stacks, is replaced with a replacement power supply stack, the control program that causes the control device to execute instructions for: determining whether there is a difference in state of charge between the parallel connected power supply stacks; and when there is a difference in state of charge between the power supply stacks, executing discharge control for discharging the power supply stacks through a predetermined electric power consuming device or charge control for charging the power supply stacks from an external charger until the state of charge of each of the power supply stacks becomes a predetermined value.

According to the aspects of the invention, with the power supply stack replacement method, which adjusts the SOC of each of the electrically parallel connected cell stacks, a reduction in travel distance based on electric energy from a power supply device after replacement of power supply stacks is prevented to make is possible to provide efficient usage of the power supply device after stack replacement and safe stack replacement work.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of a battery pack that is formed of a plurality of cell stacks;

FIG. 2 is a view that shows the circuit configuration of the battery pack;

FIG. 3 is a functional block diagram of a main controller;

FIG. 4A and FIG. 4B are views that show the processing flow of a power supply stack replacement method according to an embodiment of the invention;

FIG. 5 is a view that shows the processing flow of a power supply stack replacement method according to the embodiment of the invention;

FIG. 6 is a view that shows the processing flow of a power supply stack replacement method according to the embodiment of the invention; and

FIG. 7A and FIG. 7B are views that show the processing flow of a power supply stack replacement method according to the embodiment of the invention.

### DETAILED DESCRIPTION OF EMBODIMENTS

Hereinafter, an embodiment of the invention will be described.

A battery pack (which function as a power supply device) according to the embodiment of the invention is, for example, mounted on a vehicle, such as a hybrid vehicle and an electric vehicle. The hybrid vehicle includes an internal combustion engine or a fuel cell in addition to a battery pack 1 as a power source for propelling the vehicle. The electric vehicle includes only the battery pack as a power source of the vehicle.

The battery pack 1 according to the present embodiment is, for example, mounted on the lower surface of a floor panel of the vehicle, arranged in a space outside a vehicle cabin (space in which a passenger is seated) on the upper surface side of the floor panel between the vehicle cabin and the floor panel, or arranged under a seat, between seats or between a trunk space and the floor panel.

The battery pack 1 is connected to a motor generator (not shown). The motor generator receives the output of the battery pack 1 to generate kinetic energy for propelling the vehicle. The rotational force of the motor generator is transmitted to wheels via a power transmission mechanism.

A step-up circuit or an inverter may be arranged between the battery pack 1 and the motor generator. When the step-up circuit is arranged, the output voltage of the battery pack 1 may be stepped up. When the inverter is used, direct-current electric power output from the battery pack 1 may be converted to alternating-current electric power, and a three-phase alternating-current motor may be used as the motor generator. The motor generator converts kinetic energy generated during braking of the vehicle to electric energy, and outputs the electric energy to the battery pack 1. The battery pack 1 stores electric power from the motor generator.

In addition, the battery pack 1 is connected to auxiliaries or an external charger via the step-up circuit or the inverter. The auxiliaries are devices (electric power consuming devices) that operate by consuming electric power output from the battery pack 1, and are, for example, an air conditioner, an AV device, a lighting device, and the like, equipped for the vehicle. Note that the auxiliaries may include an externally connectable device that is not equipped for the vehicle.

The external charger is a power supply (electric power supply source) that supplies the battery pack 1 with electric energy outside the vehicle other than electric energy charged through vehicle running, and supplies electric power from a domestic power supply or an exclusive charging power supply to the battery pack 1. The external charger and the battery pack (vehicle) may be, for example, connected to each other using a charging cable that is connectable with a charging adapter equipped for the vehicle.

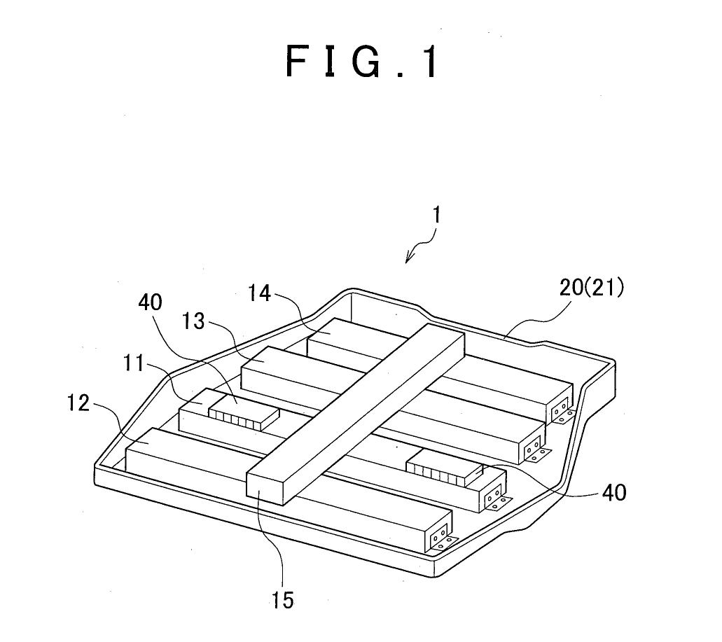

FIG. 1 is a schematic view of the battery pack that is formed of a plurality of cell stacks. The battery pack 1 includes five cell stacks (which function as power supply stacks) 11 to 15 and a case 20 that accommodates the cell stacks 11 to 15. The cell stacks 11 to 15 are covered with an upper case (not shown) and a lower case 21. The upper case is fixed to the lower case 21 by bolts, or the like. The lower case 21 is fixed to the floor panel of the vehicle by bolts, or the like. Thus, the battery pack 1 is fixed to the vehicle. In addition, the cell stacks 11 to 15 are arranged so that the four cell stacks 11 to 14 are arranged inside the lower case 21 and the cell stack 15 is arranged on these four cell stacks 11 to 14.

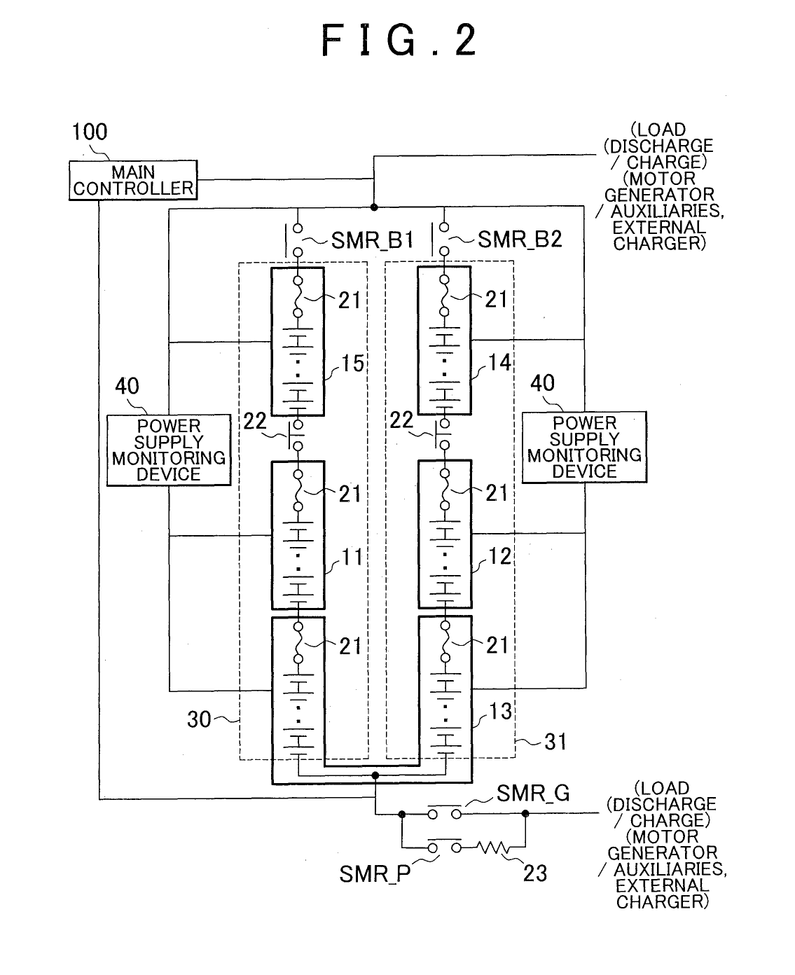

The configuration of each of the cell stacks 11 to 15 will be described. The cell stack 11 has a plurality of single cells that are arranged in one direction. A so-called prismatic battery is used as each single cell. A secondary battery, such as a nickel metal hydride battery and a lithium ion battery, may be used as each single cell. In addition, instead of the secondary battery, an electric double layer capacitor may be used. In each of the cell stacks 11 to 15 according to the present embodiment, a plurality of single cells are arranged in one direction (see FIG. 2); however, the aspect of the invention is not limited to this configuration. Specifically, the cell stack 11 may be formed so that a plurality of single cells are used to constitute a single cell module and then a plurality of the cell modules are arranged in one direction.

Each single cell includes a power generating element (which may be, for example, formed by laminating a positive electrode element, a negative electrode element and a separator (including an electrolytic solution) arranged between the positive electrode element and the negative electrode element) inside, and the adjacent two single cells are electrically connected to each other by a bus bar. A pair of end plates are respectively arranged at both ends of the cell stack 11. The plurality of single cells arranged in one direction are restrained in such a manner that the pair of end plates are restrained by a restraining member.

The five cell stacks 11 to 15 are electrically connected via a wire harness (not shown). In addition, current breakers 22 (described later) are fixed to the cell stacks 11, 12, 14 and 15. The current breakers 22 are used to interrupt the current paths of the cell stacks 11 to 15. Each current breaker 22 may be formed of a plug and a grip inserted in the plug. By removing the grip from the plug, the corresponding current path may be interrupted.

Next, the circuit configuration of the battery pack 1 will be described with reference to FIG. 2.

In the present embodiment, the five cell stacks 11 to 15 constitute two assembled cells (power supply units) 30 and 31, and the assembled cells 30 and 31 are electrically connected in parallel with each other. The number of single cells that constitute each of the assembled cells 30 and 31 is equal to each other, and each of the assembled cells 30 and 31 includes a plurality of cell stacks.

One of two cell monitoring devices 40 shown in FIG. 2 is used to monitor the state of the assembled cell 30, and the other one of the cell monitoring devices 40 is used to monitor the state of the assembled cell 31. The state of each of the assembled cells 30 and 31 includes current, voltage and temperature. The voltage includes the voltage of the corresponding one of the assembled cells 30 and 31, the voltage of each single cell, and the voltage of each of a plurality of blocks when the plurality of single cells that constitute the corresponding one of the assembled cells 30 and 31 are divided into the plurality of blocks. Each block includes two or more single cells. The temperature includes the temperature of a portion or the temperatures of multiple portions of the corresponding one of the assembled cells 30 and 31.

The current, voltage and temperature monitored by each cell monitoring device 40 are used to control charging and discharging of the cell slacks 11 to 15. For example, the current, or the like, is used to estimate (calculate) the state of charge (SOC) of each of the cell stacks 11 to 15 or used to estimate the degraded state of each of the cell stacks 11 to 15. In addition, the voltage, or the like, is used to suppress overcharging and overdischarging of each of the cell stacks 11 to 15. Each cell monitoring device 40 outputs monitoring information about the monitored (detected) current, voltage and temperature to a main controller 100.

The assembled cell 30 is formed of the two cell stacks 11 and 15 and part of the cell stack 13. The cell stacks 11 and 15 and part of the cell stack 13 are electrically connected in series with one another. The assembled cell 31 is formed of the two cell stacks 12 and 14 and part of the cell stack 13. The cell stacks 12 and 14 and part of the cell stack 13 are electrically connected in series with one another.

A fuse 21 is provided for each of the cell stacks 11 to 15. One of the current breakers 22 is provided between the cell stack 11 and the cell stack 15, and the other one of the current breakers 22 is provided between the cell stack 12 and the cell stack 14. The two current breakers 22 are integrally formed. By removing the grip of each currant breaker 22, the respective current paths of the assembled cells 30 and 31 may be interrupted at the same time.

A system main relay SMR_B1 is connected to the plus terminal of the assembled cell 30. A system main relay SMR_B2 is connected to the plus terminal of the assembled cell 31. A system main relay SMR_G is connected to the minus terminal of each of the assembled cells 30 and 31. A system main relay SMR_P and a resistor 23 are connected in parallel with the system main relay SMR_G. The on/off states of each of the system main relays SMR_B1, SMR_B2, SMR_G and SMR_P are controlled by the main controller 100 (described later). Each of the system main relays SMR_B1, and the like, is, for example, a relay switch.

In order to electrically connect the assembled cells 30 and 31 with a load (including the auxiliaries or the external charger), the system main relays SMR_B1 and SMR_B2 and the system main relay SMR_P are initially changed from the off state to the on state. Subsequently, after the system main relay SMR_G is changed from the off state to the on state, the system main relay SMR_P is changed from the on state to the off state. By so doing, the assembled cells 30 and 31 may be charged and discharged. On the other hand, by connecting the assembled cells 30 and 31 to the external charger, such as a direct-current power supply or an alternating-current power supply, the assembled cells 30 and 31 may be charged.

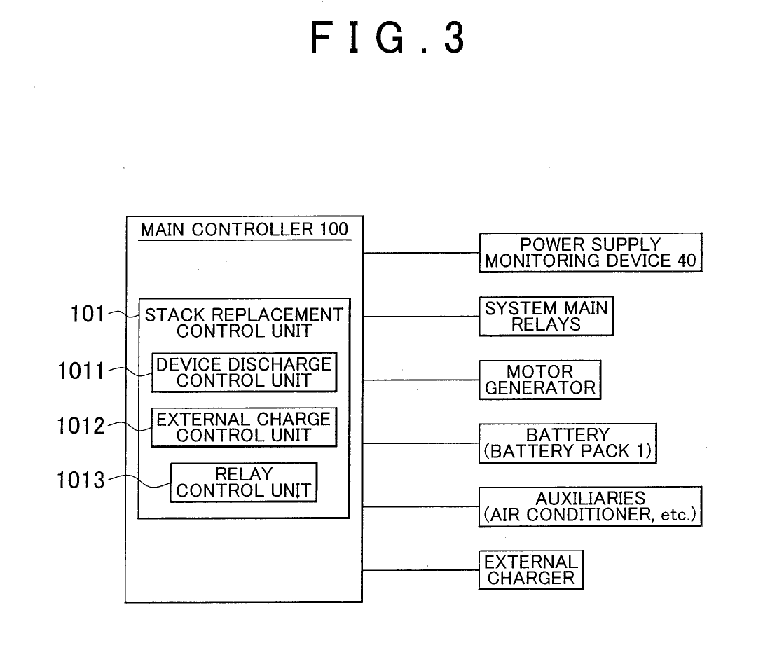

FIG. 3 is a functional block diagram of a control circuit (main controller) 100 of the battery pack 1.

The main controller 100 executes charge/discharge control over the battery pack 1 via the motor generator, the step-up circuit and the inverter, on/off control over the system main relays SMR_B1, SMR_B2, SMR_and SMR_P, monitoring control over the power supply monitoring devices 40, discharge control for discharging the battery peck 1 to the auxiliaries and charge control for charging the battery pack 1 via the external charger. The main controller 100 also executes SOC equalizing control (SOC adjusting control) in a maintenance mode (described later). Therefore, the main controller 100 according to the present embodiment includes a stack replacement control unit 101. The stack replacement control unit 101 includes a device discharge control unit 1011, an external charge control unit 1012 and a relay control unit 1013.

In addition, the main controller (including a battery controller) 100 manages the state of charge (SOC), degraded state, and the like, of each of the battery pack 1, assembled cells 30 and 31 and cell stacks 11 to 15 on the basis of the monitoring information output from the power supply monitoring devices 40 to make it possible to detect a cell stack that needs to be replaced (targeted cell stack) or, when a cell stack that needs to be replaced has been detected, output a stack replacement alarm, or the like, to a predetermined display device or output device.

The SOC of each of the assembled cells 30 and 31 may be acquired, for example, in such a manner that the main controller 100 executes predetermined processing on the basis of the monitoring information output from the power supply monitoring devices 40, and the SOC of each of the battery pack 1, assembled cells 30 and 31 and cell stacks 11 to 15 may be stored in a memory (not shown), or the like.

Then, the main controller 100 according to the present embodiment has the maintenance mode, and executes the maintenance mode on the basis of a predetermined control signal. The main controller 100 executes a stack replacement mode for replacing a targeted cell stack detected in the maintenance mode, and executes the SOC equalizing control among the cell stacks that are electrically connected in parallel with one another.

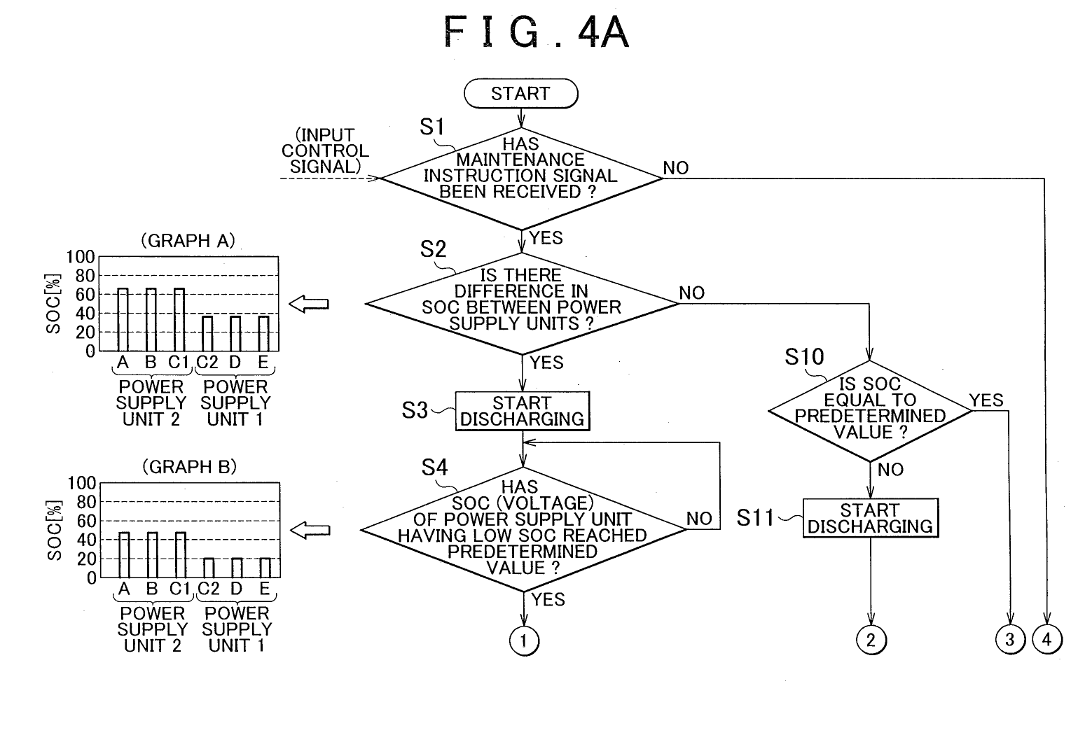

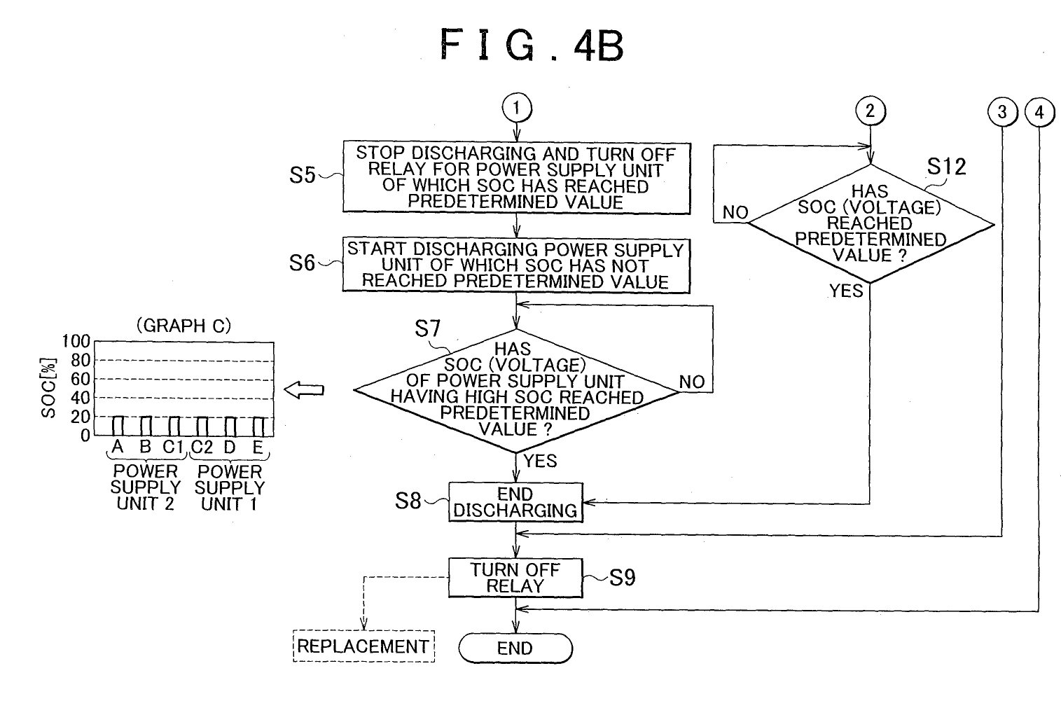

FIGS. 4A and 4B are views that show the processing flow of a power supply stack replacement method according to the present embodiment, and includes the stack replacement mode executed by the main controller 100. The processing flow of the main controller 100 after the targeted cell stack has been detected will be described below, however, the processing flow of the power supply stack replacement method is not limited to this configuration. The processing flow of the power supply stack replacement method may be configured to include a targeted cell stack detecting process executed by the main controller 100.

A worker who replaces cell stacks connects an information processing device to the main controller 100 via a predetermined connection adapter provided for the vehicle. The worker inputs a maintenance mode instruction signal (input control signal) from the information processing device. When the main controller 100 receives the maintenance instruction signal, the main controller 100 proceeds to the maintenance mode (stack replacement mode) (S1).

The main controller 100 (stack replacement control unit 101) extracts the SOC of each of the parallel connected assembled cells 30 and 31, and determines whether there is a difference in SOC (difference in voltage) between the assembled cells 30 and 31 (S2). The graph A to C at the left side of FIGS. 4A and 4B each show the SOC of each of the assembled cell 30 (power supply unit 2) and the assembled cell 31 (power supply unit 1). The cell stack 15, the cell stack 11 and part of the cell stack 13 of the assembled cell 30 respectively correspond to the cell stacks A, B and C1 of the abscissa axis, and the cell stack 14, the cell stack 12 and part of the cell stack 13 respectively correspond to the cell stacks E, D and C2 of the assembled cell 31.

The plurality of cell stacks are electrically connected in series with each other in each of the assembled cells 30 and 31, and the assembled cells 30 and 31 are electrically connected in parallel with each other, so the SOCs of the cell stack 15, the cell stack 11 and part of the cell stack 13 that constitute the assembled cell 30 are controlled so as to have the same SOC, and the SOCs of the cell stack 14, the cell stack 12 and part of the cell stack 13 that constitute the assembled cell 31 are also controlled to have the same SOC.

When it is determined that there is a difference in SOC (difference in voltage) between the assembled cells 30 and 31 (YES in S2, graph A), the main controller 100 (device discharge control unit 1011) executes discharge control in which electric energy stored in the assembled cells 30 and 31 is output to the auxiliaries (S3). Specifically, in order to electrically connect the assembled cells 30 and 31 to the auxiliaries, the main controller 100 (relay control unit 1013) changes the system main relays SMR_B1 and SMR_B2 and the system main relay SMR_P from the off state to the on state, and changes the system main relay SMR_G from the off state to the on state, and then changes the system main relay SMR_P from the on state to the off state. By so doing, the assembled cells 30 and 31 are able to discharge the stored electric energy to the auxiliaries, such as the air conditioner.

The main controller 100 discharges the whole of the parallel connected assembled cells 30 and 31 until the SOC of each of the assembled cells 30 and 31 becomes a predetermined value. The predetermined value may be, for example, the SOC of a replacement cell stack or a lower limit SOC at which the vehicle is able to run with electric energy from the battery pack 1, or may be a selected SOC.

The main controller 100 (stack replacement control unit 101) monitors variations in each SOC through discharging to the auxiliaries. In the example of FIG. 4A, as indicated by the graph B, the SOC of each of the assembled cells 30 and 31 reduces at the same time through discharging to the auxiliaries. The main controller 100 detects whether the SOC of the assembled cell 31 has reached the predetermined value (S4). In the example of FIG. 4A, the SOC of the assembled cell 31 is lower than the SOC of the assembled cell 30, so the SOC of the assembled cell 31 reaches the predetermined value in first. When the SOC of the assembled cell 31 has not reached the predetermined value, discharging is continued.

When the SOC of the assembled cell 31 has reached the predetermined value, the main controller 100 controls the system main relay to stop discharging the assembled cell 31 to the auxiliaries, and changes to discharge control over only the assembled cell 30. Specifically, the main controller 100 stops discharge control for discharging the whole of the parallel connected assembled cells 30 and 31 to the auxiliaries, changes the system main relay SMR_B2 for the assembled cell 31 from the on state to the off state, and maintains the system main relay SMR_B1 for the assembled cell 30 in the on state (S5). The main controller 100 starts discharge control in a state where the system main relays SMR_B1 and SMR_G are on, and starts discharging only the assembled cell 30 to the auxiliaries (S6).

The main controller 100 monitors variations in SOC through discharging of the assembled cell 30 to the auxiliaries. As indicated by the graph C of FIG. 4B, the main controller 100 detects whether the SOC of the assembled cell 30 has reached the predetermined value (S7). Discharging is continued when the SOC of the assembled cell 30 has not reached the predetermined value; whereas, when the SOC of the assembled cell 30 has reached the predetermined value, the main controller 100 controls the system main relay to stop discharging the assembled cell 30 to the auxiliaries, and then ends discharge control for discharging the battery pack 1 to the auxiliaries as a whole (S8).

After that, as indicated by the graph C of FIG. 4B, the main controller 100 determines whether the SOC of the assembled cell 30 and the SOC of the assembled cell 31 both are equal to the predetermined value, that is, the SOC of the assembled cell 30 and the SOC of the assembled cell 31 are equalized to the predetermined value, turns off all the system main relays SMR_B1, SMR_B2, SMR_G and SMR_P of the battery pack 1 in a state where the SOCs of the electrically parallel connected assembled cell 30 and assembled cell 31 are equalized to the predetermined value (S9), and then ends SOC adjusting control.

On the other hand, when it is determined in step S2 that there is no difference in SOC (difference in voltage) between the assembled cells 30 and 31 (NO in S2), the SOC of each of the assembled cells 30 and 31 has the same SOC, so the main controller 100 determines whether the SOC is equal to the predetermined value (S10). When the SOC of each of the assembled cells 30 and 31 is higher than the predetermined value, in order to electrically connect the assembled cells 30 and 31 to the auxiliaries, as in the case of step S3, the main controller 100 changes the system main relays SMR_B1, SMR_B2 and the system main relay SMR_G from the off state to the on state to discharge the whole of the parallel connected assembled cells 30 and 31 until the SOC of each of the assembled cells 30 and 31 becomes the predetermined value (S11).

The main controller 100 monitors variations in SOC through discharging of the assembled cells 30 and 31 to the auxiliaries. As indicated by the graph C of FIG. 4B, the main controller 100 detects whether the SOC of each of the assembled cells 30 and 31 has reached the predetermined value (S12). Discharging is continued when the SOC has not reached the predetermined value; whereas, when the SOC has reached the predetermined value, the main controller 100 proceeds to step S8.

After completion of SOC adjusting control, the main controller 100 may execute control for outputting indication, or the like, that a preparation for replacement has been finished to a worker who replaces cell stacks. The worker replaces the targeted cell stack with a replacement cell stack.

In the battery pack 1 that is formed of the electrically parallel connected sets of cell stacks, for example, when there is a malfunctioned cell stack in the battery pack 1, the main controller 100 executes control such that charging and discharging the malfunctioned cell stack (the power supply unit that includes the malfunctioned cell stack) are stopped and only the non-malfunctioned cell stacks (the non-malfunctioned power supply unit) are charged and discharged to allow running with electric energy from the battery pack 1. In this case, from the time point at which the malfunction occurs, there is a large difference in SOC among the cell stacks (between the power supply units).

Therefore, when the malfunctioned targeted cell stack is replaced with a replacement cell stack, a difference in voltage between the parallel connected sets of cell stacks increases. When there is a large difference in voltage between the sets of cell stacks after replacement, an energy loss resulting from the difference in voltage occurs.

For example, when the SOC of the power supply unit 2 is 65% and the SOC of the power supply unit 1 is 38% as shown in the graph A of FIG. 4A, the difference in SOC is 27%. If the malfunctioned cell stack is replaced without SOC adjusting control, the difference 27% in SOC between the power supply unit 1 and the power supply unit 2 is maintained as-is, so the SOC of the power supply unit 1 reaches the lower limit 20% in first during discharging the battery pack 1, discharge control is stopped even when the SOC of the power supply unit 2 is 47%, and electric energy corresponding to the SOC 27% of the power supply unit 2 is not used.

In addition, the SOC of the power supply unit 2 reaches the upper limit 80% in first during charging the battery pack 1, charge control is stopped even when the SOC of the power supply unit 1 is 53%, and electric energy corresponding to the SOC 27% of the power supply unit 1 is not stored.

Therefore, when there is a difference in SOC between the parallel connected power supply units 1 and 2, a travel distance based on electric energy after replacement of cell stacks reduces by a distance corresponding to the difference in SOC between the power supply units 1 and 2.

In the present embodiment, in replacement work for the electrically parallel connected sets of cell stacks, by executing SOC equalizing control for equalizing the SOCs of the parallel connected sets of cell stacks, it is possible to desirably prevent a reduction in travel distance based on electric energy from the battery pack 1 after replacement of cell stacks or a non-runnable state. By so doing, it is possible to efficiently use the battery pack 1 after stack replacement.

In addition, which the SOC of the replacement cell stack is used as the predetermined value for SOC equalizing control, the SOC of each of the assembled cells 30 and 31 of the battery pack 1 after stack replacement is equalized to the SOC of the replacement cell stack (the SOCs are uniformized to the same constant predetermined value), so the battery pack 1 after stack replacement may be further efficiently used.

In addition, the predetermined value for SOC adjusting control is set for the runnable lower limit based on electric energy from the battery pack 1 to equalize the SOCs of the assembled cells 30 and 31 and the SOCs of the plurality of cell stacks of the assembled cell 30 or assembled cell 31 that includes the targeted cell stack at a lower SOC, so it is possible to prevent discharging, or the like, due to a difference in voltage between the assembled cells or among the cell stacks, and it is possible to further improve the safety of work for removing the targeted cell stack and installing the replacement cell stack.

Note that, when the SOC of the replacement cell stack may be acquired in advance, the SOC of the replacement cell stack is input together with the maintenance mode instruction signal or individually from the information processing device to the main controller 100 to use the SOC input from the information processing device as the predetermined value for SOC adjusting control in the maintenance mode. In addition, when the SOC of the replacement cell stack is the SOC lower limit of the cell stack, that SOC may be held in advance and used as the predetermined value for SOC adjusting control. In addition, in order to bring the SOC of the replacement cell stack into coincidence with the predetermined value for SOC adjusting control or in order to set the SOC of the replacement cell stack at a selected predetermined value, the replacement cell stack may be charged or discharged in advance.

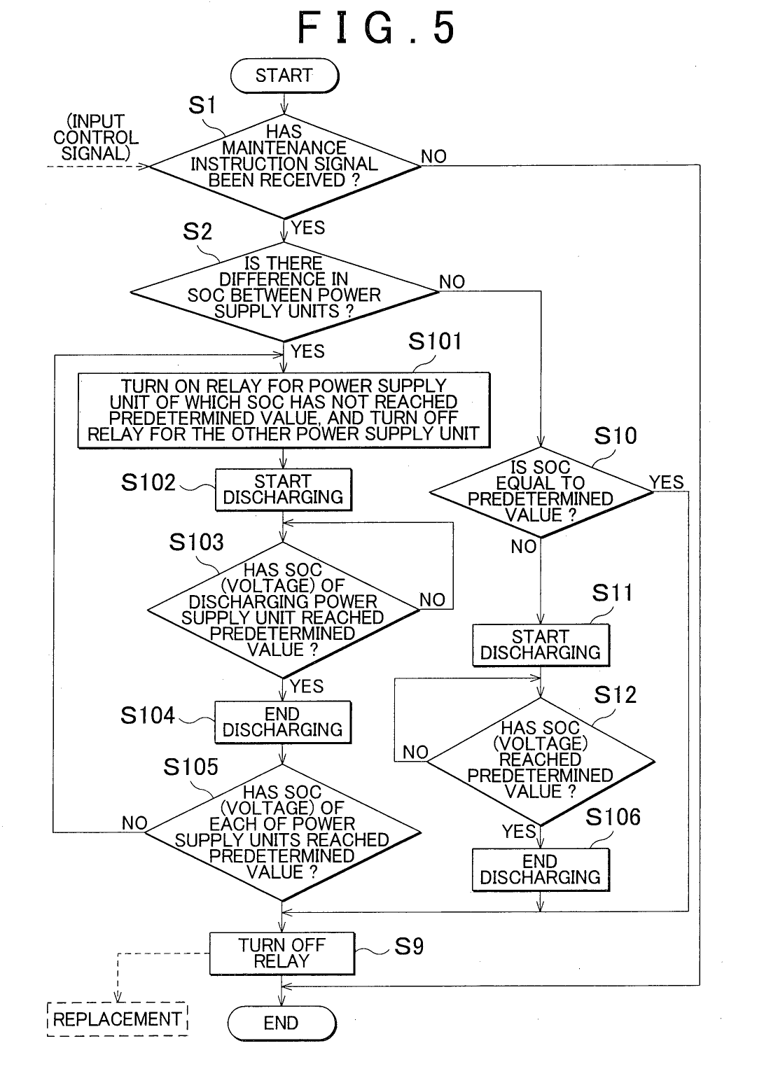

FIG. 5 is a view that shows the processing flow of a power supply stack replacement method, and is an alternative example of the power supply stack replacement method shown in FIGS. 4A and 4B. Like reference numerals denote the same processes as those of FIGS. 4A and 4B, and the description thereof is omitted.

As shown in FIG. 5, in discharge control for outputting electric energy stored in the assembled cells 30 and 31 to the auxiliaries, not all the parallel connected assembled cells 30 and 31 are discharged until the SOC of each of the assembled cells 30 and 31 becomes the predetermined value but the assembled cells 30 and 31 are individually discharged until the SOC of each of the assembled cells 30 and 31 reaches the predetermined value.

When it is determined in step S2 that there is a difference in SOC (difference in voltage) between the assembled cells 30 and 31, the main controller 100 consults die SOCs of the assembled cells 30 and 31 to determine whether the SOC of each of the assembled cells 30 and 31 is equal to the predetermined value. This determination process may be performed on the assembled cells 30 and 31 individually in a selected order. For example, when it is determined that the SOC of the assembled cell 31 is not equal to the predetermined value, the assembled cell 31 is electrically connected to the auxiliaries. The system main relay SMR_B2 is changed from the off state to the on state. By so doing, the assembled cell 31 is allowed to discharge the stored electric energy to the auxiliaries, such as the air conditioner (S101).

The main controller 100 discharges only one of the parallel connected assembled cells 30 and 31, that is, the assembled cell 31, until, for example, the SOC of the assembled cell 31 becomes the predetermined value (S103). At this time, the assembled cell 30 is not discharged.

The main controller 100 monitors variations in the SOC of the assembled cell 31 through discharging to the auxiliaries, and detects whether the SOC of the assembled cell 31 has reached the predetermined value (S103). Discharging is continued when the SOC of the assembled cell 31 has not reached the predetermined value.

When the SOC of the assembled cell 31.has reached the predetermined value, the main controller 100 controls the system main relay to stop discharging to the auxiliaries (S104), checks the SOC of each of the parallel connected assembled cells and determines whether the SOC of each of the parallel connected assembled cells (cell stacks) of the battery pack 1 is equal to the predetermined value (S105). When there is an assembled cell of which the SOC has not reached the predetermined value, the process returns to step S101 to turn on the system main relay of the assembled cell of which the SOC has not reached the predetermined value and turn off the system main relay of the other assembled cell, and discharges the assembled cell of which the SOC has not reached the predetermined value until the SOC becomes the predetermined value. Steps S101 to S105 are repeated until the SOC of each of the parallel connected assembled cells of the battery pack 1 becomes the predetermined value, and the SOCs of all the parallel connected assembled cells are equalized to the predetermined value.

In the example of FIG. 5, the SOC of each of the assembled cells is individually subjected to discharge control, and the assembled cell of which the SOC has not reached the predetermined value is subjected to discharge control, so a period of time for SOC equalizing control may be reduced.

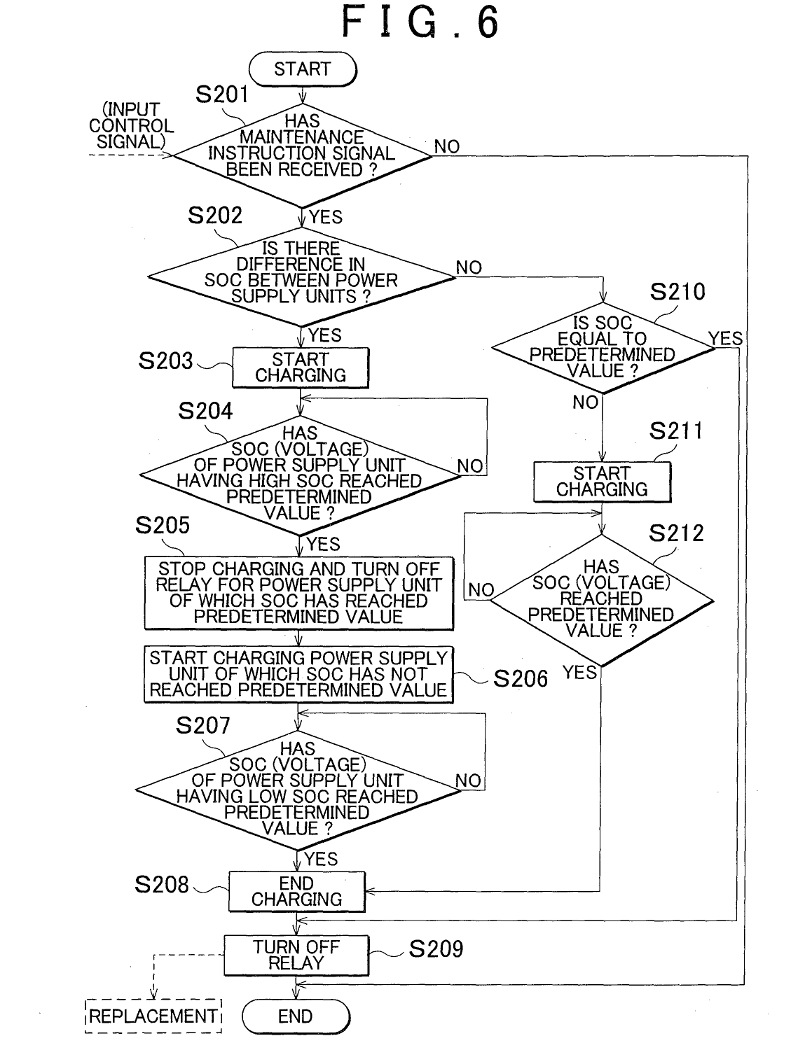

FIG. 6 is a view that shows the processing flow of a power supply stack replacement method. The power supply stack replacement method shown in FIGS. 4A and 4B execute discharge control for discharging electric energy to the auxiliaries to decrease the SOC of each cell stack to the predetermined value; whereas, in the example of FIG. 6, conversely, the parallel connected sets of cell stacks are subjected to charge control to equalize the SOCs.

As in the case of the example shown in FIGS. 4A and 4B, a worker who replaces cell stacks connects the information processing device to the main controller 100 via the predetermined connection adapter provided for the vehicle. The worker inputs the maintenance mode instruction signal (input control signal) from the information processing device. When the main controller 100 receives the maintenance instruction signal, the main controller 100 proceeds to the maintenance mode (stack replacement mode) (S201). Note that, as described above, the external charger and the battery pack 1 (vehicle) are connected to each other using a charging cable, or the like, that is connectable with the charging adapter equipped for the vehicle.

The main controller 100 acquires the SOC of each of the parallel connected assembled cells 30 and 31 from the memory, and determines whether there is a difference in SOC (difference in voltage) between the assembled cells 30 and 31 (S202).

When it is determined that there is a difference in SOC (difference in voltage) between the assembled cells 30 and 31 (YES in S202), the main controller 100 (external charge control unit 1012) executes charge control for charging the assembled cells 30 and 31 with electric energy from the external charger (S203). Specifically, in order to electrically connect the assembled cells 30 and 31 to the external charger, the main controller 100 (relay control unit 1013) changes the system main relays SMR_B1 and SMR_B2 and the system main relay SMR_G from the off state to the on state. By so doing, the assembled cells 30 and 31 are allowed to receive electric power supplied from the external charger to be charged with electric energy.

The main controller 100 charges the whole of the parallel connected assembled cells 30 and 31 from the external charger until the SOC of each of the assembled cells 30 and 31 becomes the predetermined value.

The main controller 100 (stack replacement control unit 101) monitors variations in each SOC through charging from the external charger. In the example of FIG. 6, as in the case of FIGS. 4A and 4B, the SOCs of the assembled cells 30 and 31 increase at the same time through charging from the external charger. The main controller 100 detects whether the SOC of the assembled cell 30 has reached the predetermined value (S204). In the example of FIGS. 4A and 4B, because the SOC of the assembled cell 30 is higher than the SOC of the assembled cell 31, the SOC of the assembled cell 30 reaches the predetermined value in first. Charging is continued when the SOC of the assembled cell 30 has not reached the predetermined value.

When the SOC of the assembled cell 30 has reached the predetermined value, the main controller 100 controls the system main relay to stop charging the assembled cell 30, and changes to charge control over only the assembled cell 31. Specifically, the main controller 100 stops charge control for charging the whole of the parallel connected assembled cells 30 and 31 from the external charger, changes the system main relay SMR_B1 for the assembled cell 30 from the on state to the off state, and maintains the system main relay SMR_B2 for the assembled cell 31 in the on state (S205). The main controller 100 starts charging only the assembled cell 31 from the external charger in a state where the system main relays SMR_B2 and SMR_G are on (S206).

The main controller 100 monitors variations in SOC through charging of the assembled cell 31 from the external charger. The main controller 100 detects whether the SOC of the assembled cell 31 has reached the predetermined value (S207). Charging is continued when the SOC of the assembled cell 31 has not reached the predetermined value; whereas, when the SOC of the assembled cell 31 has reached the predetermined value, the main controller 100 controls the system main relay to stop charging from the external charger, and ends charge control for charging the battery pack 1 from the external charger as a whole (S208).

After that, the main controller 100 determines whether the SOCs of the assembled cell 30 and assembled cell 31 are equalized to the same predetermined value and turn off all the system main relays SMR_B1, SMR_B2, SMR_G and SMR_P of the battery pack 1 in a state where the SOCs of the electrically parallel connected assembled cell 30 and assembled cell 31 are equalized to the predetermined value (S209) to and SOC equalizing control.

When it is determined in step S202 that there is no difference in SOC (difference in voltage) between the assembled cells 30 and 31 (NO in S202), the SOC of each of the assembled cells 30 and 31 has the same SOC, so the main controller 100 determines whether the SOC is equal to the predetermined value (S210). When the SOC of each of the assembled cells 30 and 31 is lower than the predetermined value, in order to electrically connect the assembled cells 30 and 31 to the external charger, as in the case of step S203, the main controller 100 changes the system main relays SMR_B1 and SMR_B2 and the system main relay SMR_G from the off state to the on state, charges the whole of the parallel connected assembled cells 30 and 31 with electric energy from the external charger until the SOC of each of the assembled cells 30 and 31 becomes the predetermined value (S211).

The main controller 100 monitor variations in SOC through charging of the assembled cells 30 and 31 from the external charger, and detects whether the SOC of each of the assembled cells 30 and 31 has reached the predetermined value (S212). Charging is continued when the SOC has not reached the predetermined value; whereas, when the SOC has reached the predetermined value, the main controller 100 proceeds to step S208.

After ending of SOC equalizing control, the main controller 100 may execute control for outputting indication, or the like, that a preparation for replacement has been finished to a worker who replaces cell stacks. The worker replaces the targeted cell stack with a replacement cell stack.

In the example of FIG. 6, in work for replacing the electrically parallel connected sets of cell stacks, the SOCs of the parallel connected acts of cell stacks are equalized by charging, so the SOCs are equalized in a state where the SOC of the battery pack 1 is high. Therefore, the state where electric energy sufficient to running based on electric energy from the battery pack 1 is stored is maintained after replacement of cell stacks, and a charging time using the external charger after replacement of cell stacks is reduced or charging is not required.

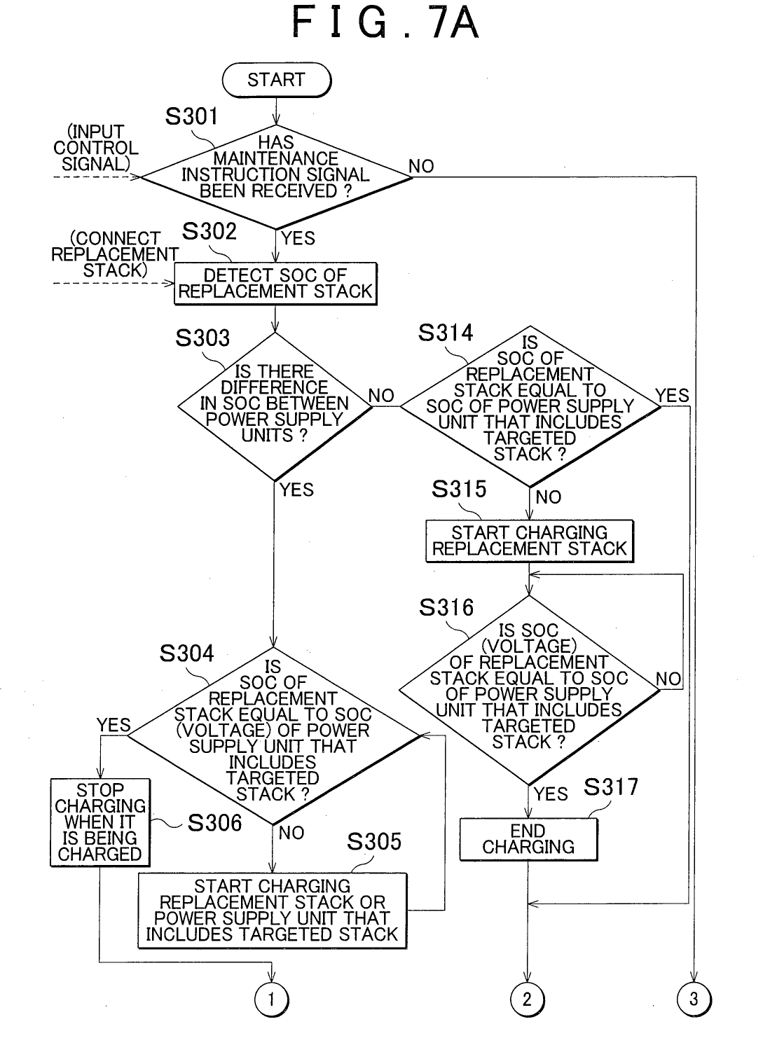

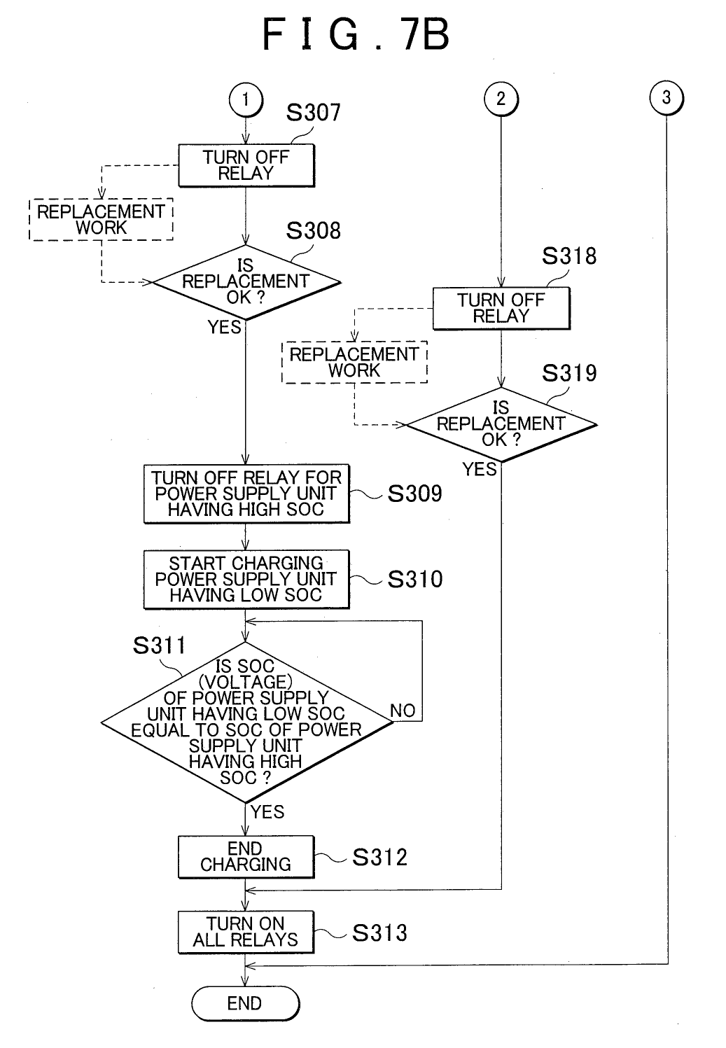

FIGS. 7A and 7B are views that shows the processing flow of a power supply stack replacement method. In FIGS. 7A and 7B, after the targeted cell stack is replaced with the replacement cell stack, SOC equalizing control for equalizing the SOCs of the parallel connected sets of cell stacks is executed. Note that, in the example of FIGS. 7A and 7B, charge control is described as an example; instead, discharge control may be applied.

A worker who replaces cell stacks connects the information processing device to the main controller 100 via the predetermined connection adapter provided for the vehicle. The worker inputs the maintenance mode instruction signal from the information processing device. When the main controller 100 receives the maintenance instruction signal, the main controller 100 proceeds to the maintenance mode (stack replacement mode) (S301).

In addition, the worker connects the replacement cell stack to the external charger and connects the external charger to the battery pack (vehicle) using the charging cable. Furthermore, the worker connects the main controller 100 to the replacement cell stack using a predetermined communication line. That is, in order to incorporate the replacement cell stack into a subject of charge/discharge control executed by the main controller 100, the replacement cell stack is connected to the main controller 100. The main controller 100 detects the SOC of the connected replacement cell stack (S302).

Note that, when the SOC of the replacement cell stack is acquired, step S302 executes the process of receiving an input of the SOC of the connected replacement cell stack from the information processing device. In addition, other than individually connecting the replacement cell stack and the battery pack 1 to the external charger, for example, it is applicable that the replacement cell stack is connected by a maintenance cable provided for the battery pack 1, the external charger and the replacement cell stack are connected via the battery pack 1 and the replacement cell stack is incorporated into a subject of charge/discharge control executed by the main controller 100.

Subsequently, the main controller 100 acquires the SOC of each of the parallel connected assembled cells 30 and 31 from the memory, and determines whether there is a difference in SOC (difference in voltage) between the assembled cells 30 and 31 (S303).

When it is determined that there is a difference in SOC (difference in voltage) between the assembled cells 30 and 31 (YES in S303), the main controller 100 (external charge control unit 1012) proceeds to step S304 and determines whether the SOC of the replacement cell stack is equal to the SOC of the assembled cell 30 or 31 that includes the targeted cell stack (whether there is a difference in SOC) (S304).

When the SOC of the replacement cell stack is not equal to the SOC of the assembled cell 30 or 31 that includes the targeted cell stack, charge control for charging the replacement cell stack or the assembled cell 30 or 31 that includes the targeted cell stack with electric energy from the external charger is executed (S305).

Here, on the assumption that the assembled cell that includes the targeted cell stack is the assembled cell 31, the case where the replacement cell stack is charged until the SOC of the replacement cell stack becomes the SOC of the assembled cell 31 that includes the targeted cell stack will be described.

The main controller 100 executes charge control such that the replacement cell stack is charged with electric energy from the external charger until the SOC of the replacement cell stack is equal to the SOC of the assembled cell 31 that includes the targeted cell stack. Note that, when the SOC of the replacement cell stack is higher than the SOC of the assembled cell 31 that includes the targeted cell stack, charge control for charging the assembled cell 31 with electric energy from the external charger may be executed or the replacement cell stack and the auxiliaries may be electrically connected by relay control to execute discharge control for discharging electric energy from the replacement cell stack to the auxiliaries.

The main controller 100 (stack replacement control unit 101) monitors variations in SOC through charging from the external charger. When it is determined in step S304 that the SOC of the replacement cell stack is equal to the SOC of the assembled cell 31 that includes the targeted cell stack, the process proceeds to step S306 to stop charge control, and then proceeds to step S307.

In step S307, in a state where the SOC of the replacement cell stack is equal to the SOC of the assembled cell 31 that includes the targeted cell stack, all the system main relays SMR_B1, SMR_B2, SMR_G and SMR_P of the battery pack 1 are turned off to interrupt connection between the replacement cell stack and the external charger (S307). The main controller 100, for example, executes control for outputting indication, or the like, that a preparation for replacement has been finished to a worker who replaces cell stacks, and the worker replaces the targeted cell stack with the replacement cell stack.

The main controller 100 determines whether the targeted cell stack has been replaced with the replacement cell stack (S308). The worker inputs a control signal that indicates completion of replacement of cell stacks from the information processing device to the main controller 100 after completion of stack replacement work, and the main controller 100 is able to determine whether the targeted cell stack has been replaced with the replacement cell stack on the basis of the input signal.

After being replaced with the replacement cell stack, the main controller 100 turns off the system main relay for one of the assembled cells 30 and 31, having a high SOC, and turns on the system main relay for the other one of the assembled cells 30 and 31, having a low SOC (S309). In the example of FIGS. 7A and 7B, the SOC of the assembled cell 30 is higher than the SOC of the assembled cell 31, so, in order to electrically connect the assembled cell 31 to the external charger, the system main relay SMR_B1 is turned off, while the system main relay SMR_B2 and the system main relay SMR_G are changed from the off state to the on state.

The main controller 100 executes charge control such that the assembled cell 31 (S310) is charged with electric energy from the external charger until the SOC of the assembled cell 31 reaches the SOC of the assembled cell 30.

The main controller 100 monitors variations in SOC through charging from the external charger, and executes charge control until the SOCs of the assembled cells 30 and 31 are equal to each other (S311), and, when it is determined that the SOCs of the assembled cells 30 and 31 are equal to each other, stops charge control (S312).

Then, the main controller 100 turns on all the system main relays SMR_B1, SMR_B2, SMR_G and SMR_P of the battery pack 1 (S313).

When it is determined in step S303 that there is no difference in SOC (difference in voltage) between the assembled cells 30 and 31 (NO in S303), the main Controller 100 proceeds to step S314, and determines whether the SOC of the replacement cell stack is equal to the SOC of the assembled cell 31 that includes the targeted cell stack (S314).

When the SOC of the replacement cell stack is not equal to the SOC of the assembled cell 31 that includes the targeted cell stack, charge control for charging the replacement cell stack with electric energy from the external charger is executed (S315). Note that, in this case as well, as described above, when the SOC of the replacement cell stack is higher than the SOC of the assembled cell 31 that includes the targeted cell stack, charge control for charging the assembled cell 31 with electric energy from the external charger may be executed or the replacement cell stack and the auxiliaries may be electrically connected by relay control to execute discharge control for discharging electric energy from the replacement cell stack to the auxiliaries.

The main controller 100 monitors variations in SOC through charging from the external charger, and, when it is determined that the SOC of the replacement cell stack is equal to the SOC of the assembled cell 31 that includes the targeted cell stack (S316), stops charge control (S317).

In a state where the SOC of the replacement cell stack is equal to the SOC of the assembled cell 31 that includes the targeted cell stack, the main controller 100 turns off all the system main relays SMR_B1, SMR_B2, SMR_G and SMR_P of the battery pack 1 to interrupt connection between the replacement cell stack and the external charger (S318). The main controller 100, for example, executes control for outputting indication, or the like, that a preparation for replacement has been finished to a worker who replaces cell stacks, and the worker replaces the targeted cell stack with the replacement cell stack. The main controller 100 determines whether the targeted cell stack has been replaced with the replacement cell stack (S319). Then, the main controller 100 proceeds to step 313.

In the example of FIGS. 7A and 7B, the SOC of the replacement cell stack is equalized to the SOC of the assembled cell that includes the targeted cell stack and the cell stacks are replaced, and then SOC equalizing control for equalizing the SOCs of the electrically parallel connected assembled cells 30 and 31 is executed, so the state where electric energy sufficient to naming based on electric energy from the battery pack 1 is stored is maintained after replacement of cell stacks, and a charging time using the external charger after replacement of cell stacks may be reduced.

The aspect of the invention is described with reference to the embodiments, and, for example, SOC equalizing control executed by the main controller 100 may be conducted by the information processing device operated by a worker, and may be configured separately from the main controller 100 as a control device that executes SOC equalizing control.

1. A power supply stack replacement method that, in a power supply device in which power supply stacks are electrically connected in parallel with each other, replaces a targeted power supply stack, which is part of the power supply stacks, with a replacement power supply stack, comprising:
discharging or charging the parallel connected power supply stacks until a state of charge of each of the power supply stacks becomes a predetermined value; and
replacing the targeted power supply stack among the power supply stacks of which each state of charge is the predetermined value through the discharging or charging with the replacement power supply stack; and
determining whether there is a difference in state of charge between the parallel connected power supply stacks.

2. The power supply stack replacement method according to claim 1, wherein the discharging or charging the parallel connected power supply stacks includes: discharging or charging a whole of the parallel connected power supply stacks; and stopping discharging or charging one of the power supply stacks of which the state of charge has reached the predetermined value and discharging or charging the other one of the power supply stacks of which the state of charge has not reached the predetermined value until the state of charge of the other one of the power supply stacks reaches the predetermined value.

3. The power supply stack replacement method according to claim 1, wherein the discharging or charging the parallel connected power supply stacks includes: discharging or charging a selected one of the parallel connected power supply stacks until a state of charge of the selected one of the power supply stacks becomes the predetermined value; and, after the state of charge of the selected one of the power supply stacks has reached the predetermined value, discharging or charging the other one of the parallel connected power supply stacks until a state of charge of the other one of the power supply stacks becomes the predetermined value.

4. The power supply stack replacement method according to claim 3, wherein the discharging or charging the parallel connected power supply stacks includes: discharging the parallel connected power supply stacks until a state of charge of one of the power supply stacks, having a low state of charge, becomes the predetermined value; and, after the state of charge of the one of the power supply stacks, having a low state of charge, has reached the predetermined value, discharging the other one of the parallel connected power supply stacks until a state of charge of the other one of the parallel connected power supply stacks becomes the predetermined value.

5. The power supply stack replacement method according to claim 3, wherein the discharging or charging the parallel connected power supply stacks includes: charging the parallel connected power supply stacks until a state of charge of one of the power supply stacks, having a high state of charge, becomes a predetermined value; and, after the state of charge of the one of the power supply stacks, having a high state of charge, has reached the predetermined value, charging the other one of the parallel connected power supply stacks until a state of charge of the other one of the power supply stacks becomes the predetermined value.

6. The power supply stack replacement method according to claim 1, wherein a discharge current from the parallel connected power supply stacks is output to an electric power consuming device.

7. The power supply stack replacement method according to claim 6, wherein the electric power consuming device is equipped for a vehicle.

8. The power supply stack replacement method according to claim 1, wherein the power supply stacks are charged with electric power supplied from an external charger.

9. (canceled)

10. The power supply stack replacement method according to claim 1, wherein the predetermined value is a state of charge of the replacement power supply stack.

11. The power supply stack replacement method according to claim 1, wherein the predetermined value is a lower limit of a state of charge at which a vehicle is able to run with electric energy from the power supply device.

12. A power supply stack replacement method that, in a power supply device in which power supply stacks are electrically connected in parallel with each other, replaces a targeted power supply stack, which is part of the power supply stacks, with a replacement power supply stack, comprising:
discharging or charging the replacement power supply stack until a state of charge of the replacement power supply stack is equal to a state of charge of one of the parallel connected power supply stacks;
discharging or charging the other one of the parallel connected power supply stacks until a state of charge of the other one of the power supply stacks is equal to the state of charge of the one of the power supply stacks; and
replacing the targeted power supply stack among the parallel connected power supply stacks with the discharged or charged replacement power supply stack; and
determining whether there is a difference in state of charge between the parallel connected power supply stacks.

13. A power supply stack replacement method that, in a power supply device in which power supply units, each of which is formed of a plurality of electrically connected power supply stacks, are electrically connected in parallel with each other, replaces a targeted power supply stack, which is part of the power supply stacks included in any one of the power supply units, with a replacement power supply stack, comprising:
discharging or charging the power supply units until a state of charge of each of the power supply units becomes a predetermined value;
replacing the targeted power supply stack among the power supply stacks included in the power supply units of which each state of charge is the predetermined value through the charging or discharging with the replacement power supply stack; and
determining whether there is a difference in state of charge between the parallel connected power supply stacks.

14. The power supply stack replacement method according to claim 1, wherein each of the power supply units is formed of the same number of single cells.

15. A control device that, when a targeted power supply stack, which is part of power supply stacks included in a power supply device in which the power supply stacks are electrically connected in parallel with each other, is replaced with a replacement power supply stack, controls a state of charge of each of the power supply stacks, comprising:
a stack replacement control unit that determines whether there is a difference in state of charge between the parallel connected power supply stacks; and
a charge/discharge control unit that, when there is a difference in state of charge between the power supply stacks, executes discharge control for discharging the power supply stacks through a predetermined electric power consuming device or charge control for charging the power supply stacks from an external charger until the state of charge of each of the power supply stacks becomes a predetermined value.

16. A computer-readable storage medium storing a control program executable on a control device that is connected to a power supply device in which power supply stacks are electrically connected in parallel with each other and that executes a maintenance mode in which a targeted power supply stack, which is part of the power supply stacks, is replaced with a replacement power supply stack, the control program that causes the control device to execute instructions for:
determining whether there is a difference in state of charge between the parallel connected power supply stacks; and
when there is a difference in state of charge between the power supply stacks, executing discharge control for discharging the power supply stacks through a predetermined electric power consuming device or charge control for charging the power supply stacks from an external charger until the state of charge of each of the power supply stacks becomes a predetermined value.
